(19) United States
(12) Patent Application Publication
(10) Pub. No.: US 2011/0239910 A1
(43) Pub. Date: Oct. 6, 2011

(54) Product Carriers and Methods for Making the Same

(76) Inventor: Jerry P. Chambless, Conyers, GA (US)

(21) Appl. No.: 12/753,704

(22) Filed: Apr. 2, 2010

(51) Int. Cl. B65D 19/26; B65D 19/38; B65D 19/06; B32B 38/10

(52) U.S. Cl. 108/57.16; 108/51.11; 108/57.31; 156/258

(57) ABSTRACT

A product carrier includes a corrugated fiberboard planer member having a top surface and an opposite bottom surface. At least one elongated core member has a top side, a bottom side, an open interior portion and two parallel edges running along the core member adjacent to the top side. The core member is disposed so as to depend downwardly from the bottom surface of the planar member. A glue is disposed between each of the parallel edges of the core member and the bottom surface of the planar member so as to affix the parallel edges of the core member to the bottom surface of the planar member.

### BACKGROUND OF THE INVENTION

1. Field of the Invention

The present invention relates to product carriers and, more specifically, a product that includes fiberboard materials.

2. Description of the Prior Art

Product carriers are used to support products that are shipped from one place to another or moved about in warehouses. One type of product carrier is a pallet that is used to support items that are moved about using a fork lift. Typical pallets are made of wood, which is relatively expensive. Also, wooden pallets are typically used only one or a few times due to requirements placed on the pallets by various regulations. Once used the maximum number of times, such pallets are discarded. The vast quantities of pallets that are discarded annually have a significant detrimental effect on environmental waste disposal systems.

To reduce the problems associated with wooden pallets, several manufacturers have introduced pallets made from fiberboard, which is generally recyclable. However, such pallets usually involve complicated interlocking structures that are expensive and time consuming to make.

Therefore, there is a need for an inexpensive product carrier that is recyclable.

### SUMMARY OF THE INVENTION

The disadvantages of the prior art are overcome by the present invention which, in one aspect, is a product carrier that includes a corrugated fiberboard planar member having a top surface and an opposite bottom surface. At least one elongated core member has a top side, a bottom side, an open interior portion and two parallel edges running along the core member adjacent to the top side. The core member is disposed so as to depend downwardly from the bottom surface of the planar member. A glue is disposed between each of the parallel edges of the core member and the bottom surface of the planar member so as to affix the parallel edges of the core member to the bottom surface of the planar member.

In another aspect, the invention is a pallet that includes a corrugated fiberboard planar member and at least two spaced apart parallel elongated semi-cylindrical core members. The corrugated fiberboard planar member has a top surface and an opposite bottom surface. The two spaced apart parallel elongated semi-cylindrical core members each have a top side, an open interior portion and two parallel edges running along each core member adjacent to the top side. Each core member is disposed so as to depend downwardly from the bottom surface of the planar member. A glue is disposed between each of the parallel edges of the core members and the bottom surface of the planar member so as to affix the parallel edges of the core members to the bottom surface of the planar member.

In yet another aspect, the invention is a method of making a product carrier, in which a planar piece of fiberboard is cut to a predetermined dimension to form a rectangular planar member having a bottom side. A cylindrical core is cut lengthwise so as to form two semi-cylindrical core members. Each core member includes two parallel top edges and a rounded bottom. A glue is applied to the top edges of the core members. The top edges of the core members are held against the bottom side of the planar member until the glue sets so that the core members are spaced apart and are parallel to each other.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a bottom perspective view of a pallet made according to one embodiment of the invention.

FIG. 1B is a bottom plan view of a pallet prior to the end wall being folded upwardly.

FIG. 1C is a side elevational view of the pallet shown in FIG. 1B.

FIG. 1D is a bottom plan view of the pallet shown in FIG. 1A.

FIG. 1E is a side elevational view of the pallet shown in FIG. 1A.

FIG. 2 is a perspective view of a core member.

FIG. 3A is a perspective view of a two core member embodiment.

FIGS. 3B-3D are side elevational view diagrams showing one method of assembling a product carrier of the type shown in FIG. 3A.

FIG. 4A is a perspective view of a product carrier that is configured to receive fork lift forks from all four sides.

FIGS. 4B-4C are side elevational views diagrams of the product carrier pallet shown in FIG. 4A.

FIG. 5A is a perspective view of an individual product carrier embodiment.

FIG. 5B is a top plan view of a plurality of individual product carriers formed on a single sheet of fiberboard.

FIGS. 5C-5E are side elevational view diagrams showing an individual product carrier unit being removed from a sheet of units.

FIG. 5F is a side elevational view of a plurality of individual product carriers used to support a stack of bulk sheet material.

FIG. 6A is a bottom plan view of a product carrier employing core members having a rectangular cross section.

FIG. 6B is a side elevational view of the carrier shown in FIG. 6A.

FIG. 7A is a top perspective view diagrams of a folded corrugated pallet.

FIG. 7B is a side elevational view diagrams of the pallet shown in FIG. 7A.

FIG. 7C is a side elevational view diagrams of the pallet shown in FIG. 7A being assembled.

FIG. 7D is an exploded perspective view diagrams of the pallet shown in FIG. 7A.

FIG. 8 is a bottom plan view of a pallet configured for use with a pallet jack.

FIG. 9A is a top plan view of a folded corrugated pallet employing core members to add support thereto.

FIG. 9B is a side elevational view of the folded corrugated pallet shown in FIG. 9A.

FIG. 9C is an exploded perspective view of the folded corrugated pallet shown in FIG. 9A.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

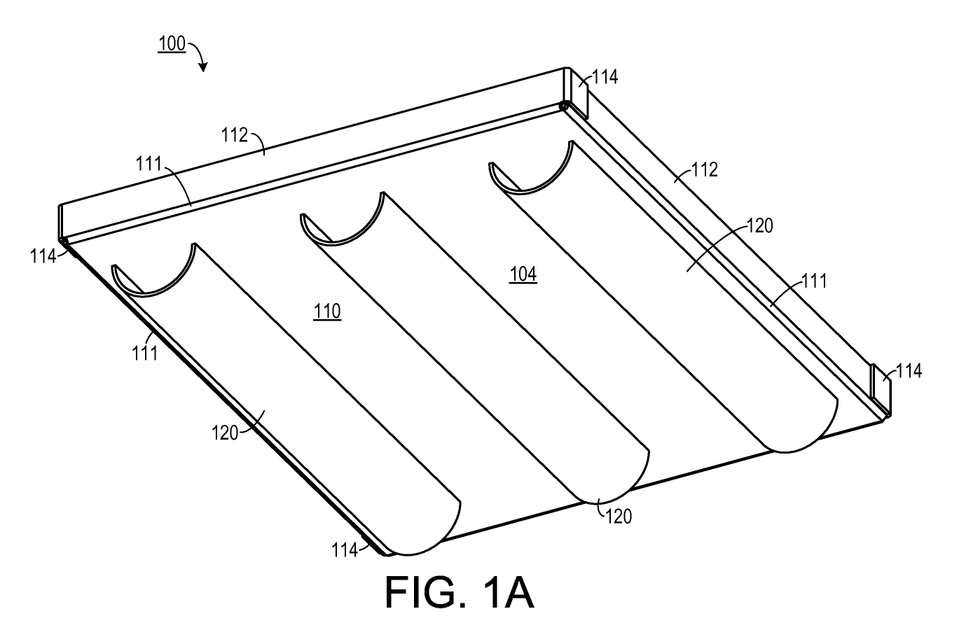

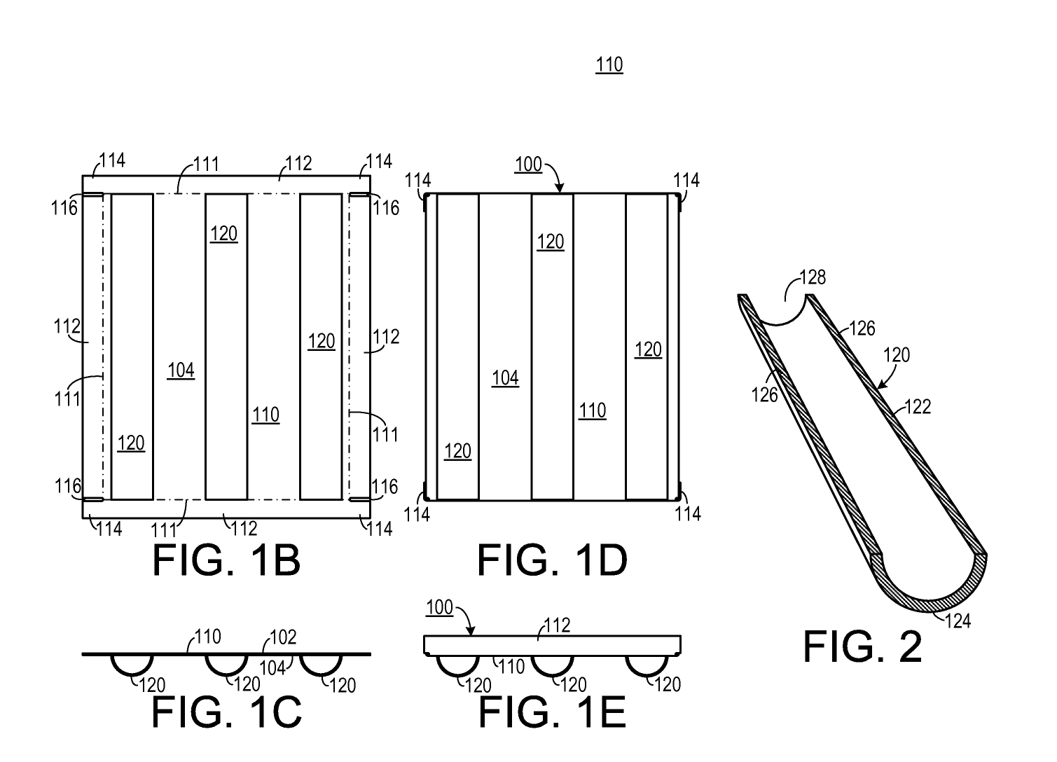

As shown in FIGS. 1A-1E, one embodiment of a product carrier, configured as a pallet 100, includes a corrugated fiberboard planar member 110 that has a top surface 102 and an opposite bottom surface 104. One or more elongated core members 120 (in the embodiment shown in FIGS. 1A-1E, three core members 120 are employed) depend downwardly from the bottom surface 104 of the planar member 110. In one representative embodiment the planar member 110 uses ECT 48 fiberboard, which is available from Georgia Pacific Corp. and International Paper Corp. However, it will be readily appreciated that other grades of fiberboard may be used, without departing from the scope of the invention, to meet specific application requirements.

As shown in FIG. 2, each core member 120 has a top side 122, a bottom side 124, an open interior portion 128 and two parallel edges 126 running along the core member 120 adjacent to the top side 122. In this embodiment the core member 120 has a hemi-cylindrical shape in which a rounded bottom side 124 is disposed oppositely from the top side 122 and the interior portion 128 opens to the top side 122. The core member 120 can be made from a paper material, such as a recycled core from a large roll of a bulk material (e.g., a large paper roll). It could also be made from a plastic tube, or other materials, depending upon the specific application. One representative embodiment employs paper table cores, available from Sonoco and Newark Paperboard, that have been cut lengthwise (e.g., with an industrial grade band saw) into two hemi-cylindrical core members 120. In one embodiment, a 6.04″ inside diameter core with a 0.210″ wall thickness is used. However, it will be readily appreciated that other types of core may be used to meet specific application requirements without departing from the scope of the invention.

Returning to FIGS. 1A-1E, the planar member 110 has a peripheral edge 111 from which a vertical edge wall 112 extends upwardly. The vertical edge wall 112 can simply be a strip of corrugated fiberboard extending from the planar member 110 that is folded upwardly and held in place glued end tabs 114 that are formed by cutting out notches 116 from the strip. (FIGS. 1B and 1C show the pallet prior to the formation of the end wall 112, whereas FIGS. 1A, 1D and 1E show the pallet with the end wall 112 folded up.) Also, some or all of the components of the product carrier 100 can be coated with a water resistant coating (such as a plastic or a wax) for use in high humidity applications.

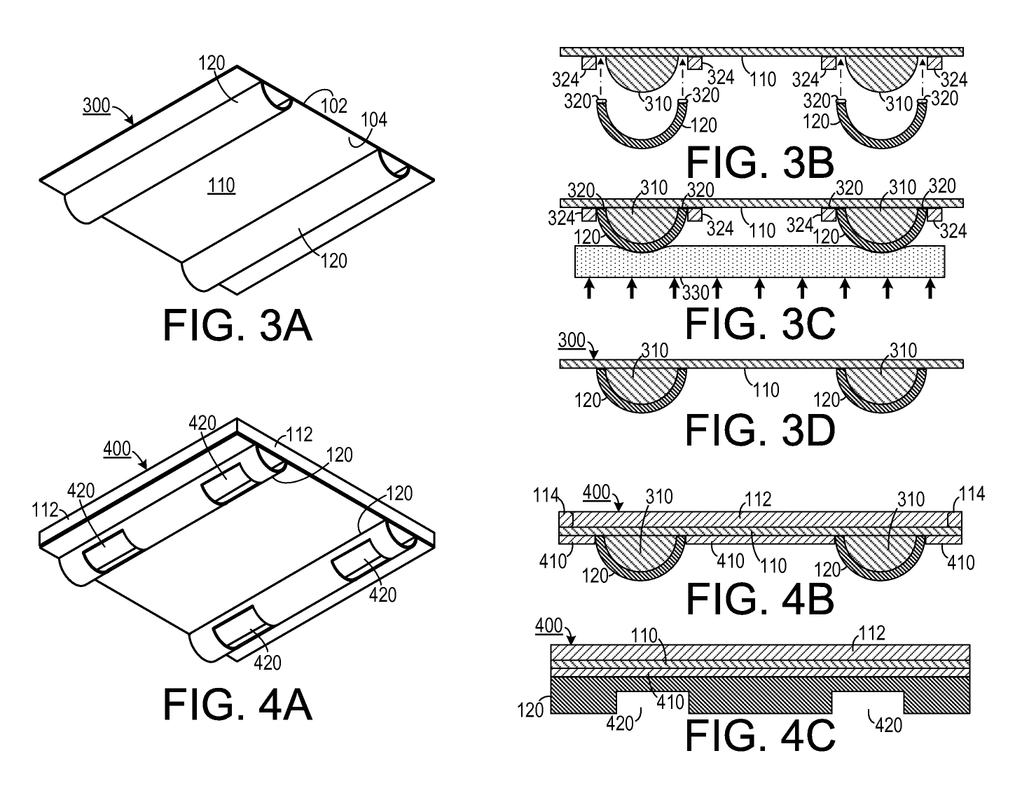

As shown in FIGS. 3A-3D, the carrier 300 can employ two core members 120 for certain applications. As shown in FIG. 3B, one embodiment includes tabs 310 die cut in the planar member 110 that have a shape that is complimentary to the interior portion of the core members 120 and folded into the interior portion of the core members 120 to provide additional support to the core members 120. In making the pallet 300, the glue 320 is applied to the parallel edges of the core members 120 (and can also be applied to the edges of the tabs 310). In one embodiment, adapted for carrying super sacks, the carrier 300 can be inverted with the core members 120 extending upwardly.

As shown in FIG. 3C, the core members 120 are placed against the bottom of the planar member 110 and they can be aligned with their proper location using a removable frame 324. Once in place, the core members can be held in place with a strip of foam 330 and pressure is applied in the direction of the arrows. The foam 330 holds the core members 120 in place and prevents them from spreading outwardly while the glue 320 sets. In one embodiment using cold glue (such as a water soluble cold glue), the pressure is applied for at least 8 minutes while the glue 320 sets. (It should be recognized that hot glue can be used in some applications.)

In one embodiment glues such as GBSA410X and GBSA710X available from Wisdom Adhesives, 1575 Executive Drive, Elgin, Ill. 60123 may be used. These glues are biodegradable and provide sufficient holding power for many applications.

In one embodiment, shown in FIGS. 4A-4C, the pallet 400 may be configured to accept forklift forks from all four sides. In such an embodiment, the core members 120 could define openings 420 sized and disposed to receive forklift forks therethrough. These openings can also be reinforced using tabs cut into the planar member 110 (not shown) similar to the tabs 310 disclosed above. Also, rectangular buildup members 410 can be glued to the planar member 110 to provide additional strength to the planar member 110 and to provide lateral support to the core members 120, thereby preventing them from spreading out during use.

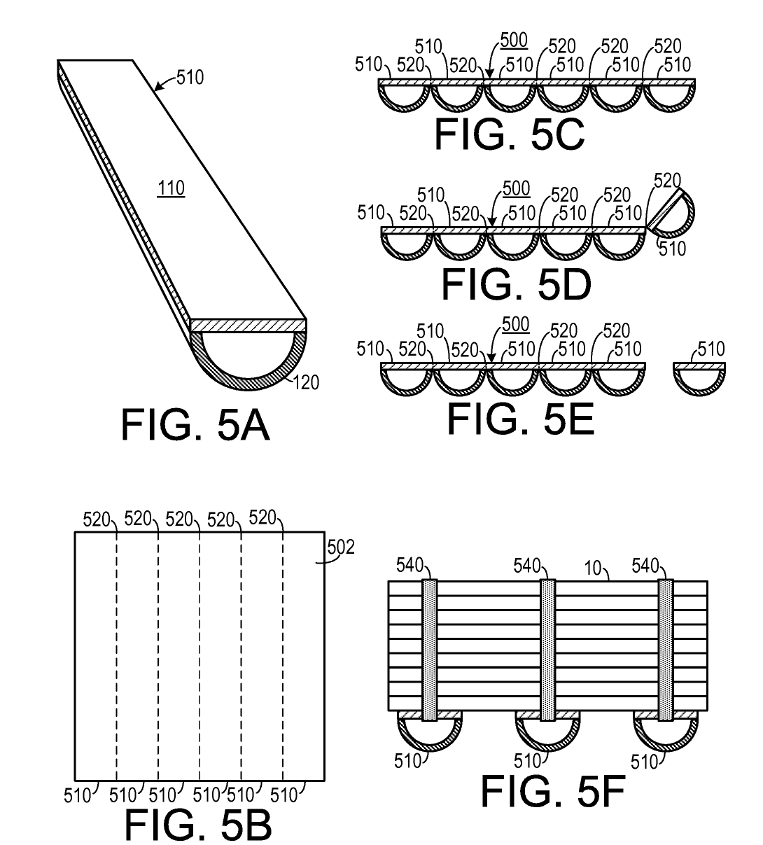

As shown in FIGS. 5A-5F, single product carrier units 510 can be made that include only a single core member 120 glued to a planar member 110 for certain applications. For example, as shown in FIG. 5F, such units 510 can be used to support bulk rigid sheet materials such as a stack 10 of wallboard by securing several spaced apart individual carrier units 510 to the stack 10 and passing elongated straps 540 (such as nylon straps) through the carrier units 510 and around the stack 10.

As shown in FIGS. 5B-5E, the individual units can be manufactured on a sheet 502 of fiberboard that has been scored with perforations 520 between the units 510. The perforations 520 allow the individual carrier units 510 to be broken away from the sheet as they are needed.

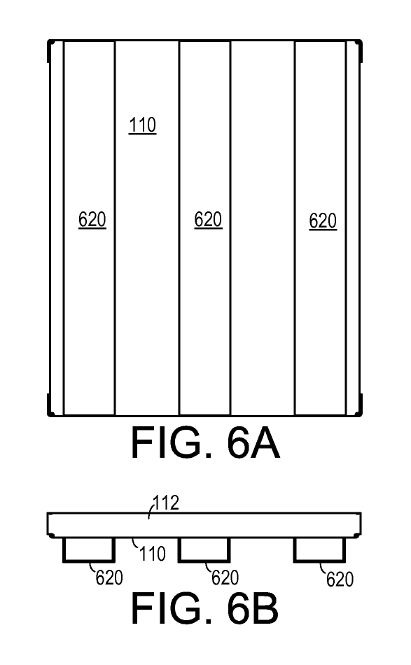

Rather than using hemi-cylindrical core members, as shown in FIGS. 6A-6B, core members 620 with a rectangular cross section can be used in some embodiments. Such core members 620 could be made, for example, from folded fiberboard.

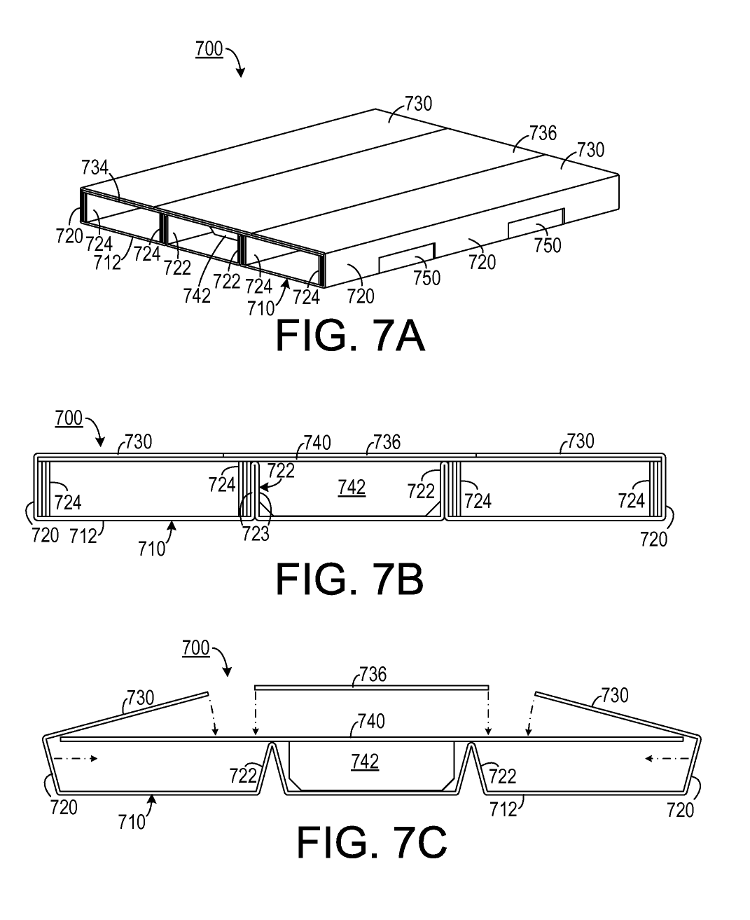

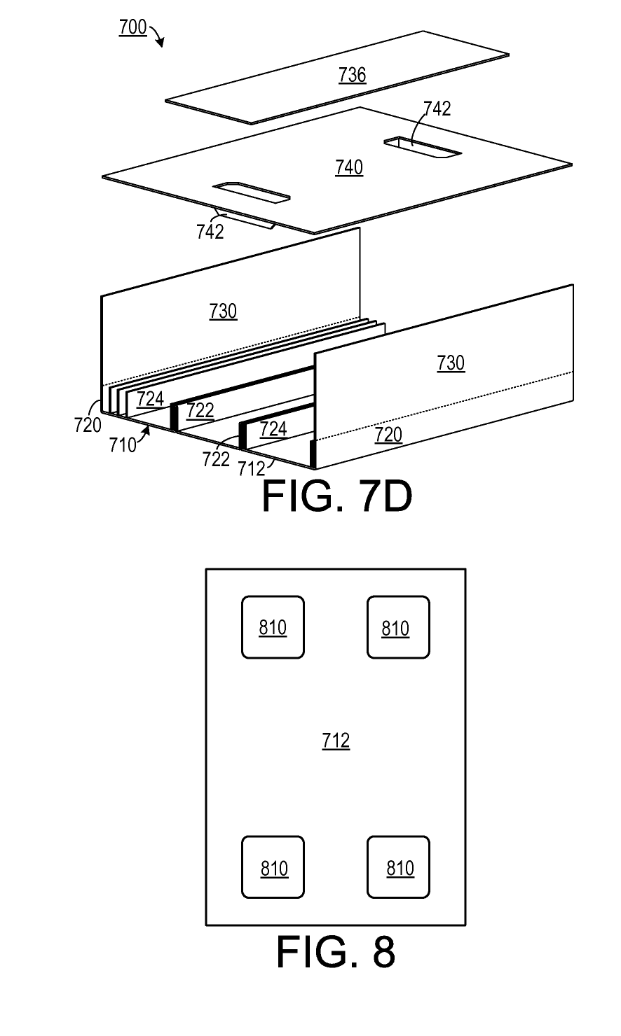

One embodiment of a corrugated fiberboard pallet 700, as shown in FIGS. 7A-7D, can include a fiberboard member 710 that includes two side walls 720 folded up from the fiberboard member and one or more vertical folds 722 folded from a bottom side 712 of the fiberboard member 710. Two top flaps 730 are folded downwardly from the side walls 720. The vertical folds 722 include two vertical portions 723 that are glued to each other to maintain their vertical position. Fiberboard strips 724 can be glued to the vertical folds 722 to provide additional support.

A fiberboard top member 740 is placed on top of the vertical folds 722 and glued thereto. Support tabs 742 can be cut into the top member 740 and folded down into the area defined by the vertical folds 722. The tabs 742 are then glued to the folds 722 so as to provide additional structural support. The two top flaps 730 are folded down onto the top member 740 and glued thereto. A fiberboard center panel 736 is then glued to the top member 740 between the top flaps 730 and is glued thereto.

Optionally, openings can be defined in the side walls 750, the vertical folds 722 and the fiberboard strips 724 to receive fork lift forks. In this way, the pallet 700 can be engaged either from the ends or the sides.

In an embodiment shown in FIG. 8, the bottom side 712 could define a plurality of holes 810 shaped and disposed so as to allow a wheel of a pallet jack to fit therein when the pallet jack is used to lift the product carrier.

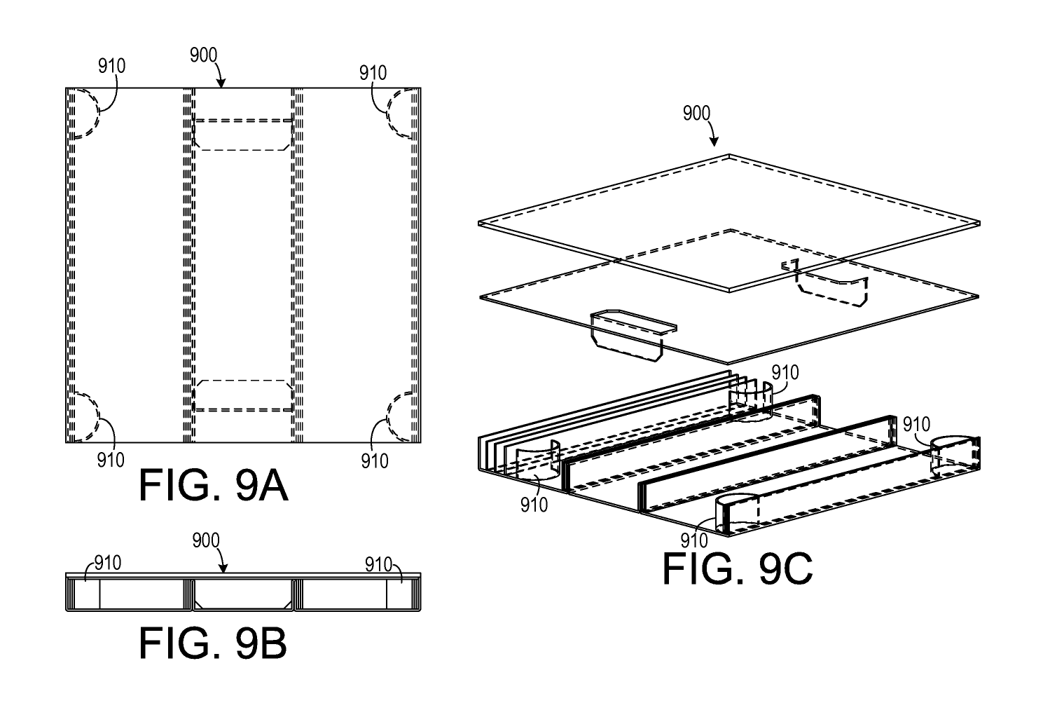

In one embodiment shown in FIGS. 9A-9C, vertical hemi-cylindrical core members 910 can be employed to provide additional structural integrity to the pallet 900. Such vertical core members 910 would be glued to the interior portion of the pallet adjacent to the sides thereof.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A product carrier, comprising:
a. a corrugated fiberboard planar member having a top surface and an opposite bottom surface;
b. at least one elongated core member having a top side, a bottom side, an open interior portion and two parallel edges running along the core member adjacent to the top side, the core member disposed so as to depend downwardly from the bottom surface of the planar member; and
c. a glue disposed between each of the parallel edges of the core member and the bottom surface of the planar member so as to affix the parallel edges of the core member to the bottom surface of the planar member.

2. The product carrier of claim 1, further comprising an elongated rectangular fiberboard buildup member that is disposed adjacent to one of the parallel edges of the elongated core member and that is glued to the planar member so as to provide lateral support to the elongated core member.

3. The product carrier of claim 1, wherein the core member has a semi-cylindrical shape in which a rounded bottom side is disposed oppositely from the top side and wherein the interior portion opens to the top side.

4. The product carrier of claim 1, wherein the core member has a cross section that is rectangular in shape.

5. The product carrier of claim 1, wherein the core member comprises a paper material.

6. The product carrier of claim 5, further comprising a water resistant coating applied to at least a portion of the product carrier.

7. The product carrier of claim 1, wherein the core member comprises a plastic.

8. The product carrier of claim 1, wherein a plurality of elongated core member are affixed to the bottom side of the planar member and wherein the planar member includes a linear perforation passing therethrough between each core member, thereby facilitating separation of the core members from each other.

9. The product carrier of claim 1, further comprising a least one flap cut into the planar member and folded downwardly into the open interior portion of the core member, wherein the flap has a shape that is complimentary in shape to an inner surface of the interior portion of the core member, the flap being glued to the inner surface so as to provide support to the core member.

10. The product carrier of claim 1, wherein the planar member has a peripheral edge and further comprising a vertical edge wall that extends upwardly from the peripheral edge.

11. The product carrier of claim 10, wherein the edge wall comprises corrugated fiberboard that has been folded upwardly from the planar member.

12. The product carrier of claim 1, wherein at least two parallel elongated core members are affixed to the bottom surface of the planar member so as to depend downwardly therefrom.

13. The product carrier of claim 12, wherein the elongated core members each define at least two spaced apart openings adjacent the bottom side the openings having a dimension that allows forks of a forklift to fit therethrough and to engage the product carrier, thereby allowing the forks to engage the product carrier from two transverse directions.

14. The product carrier of claim 1, wherein the planar member defines at least one hole shaped and disposed so as to allow a wheel of a pallet jack to fit therein when the pallet jack is used to lift the product carrier.

15. A pallet, comprising:
a. a corrugated fiberboard planar member having a top surface and an opposite bottom surface;
b. at least two spaced apart parallel elongated semi-cylindrical core members each having a top side, an open interior portion and two parallel edges running along each core member adjacent to the top side, each core member disposed so as to depend downwardly from the bottom surface of the planar member; and
c. a glue disposed between each of the parallel edges of the core members and the bottom surface of the planar member so as to affix the parallel edges of the core members to the bottom surface of the planar member.

16. The pallet of claim 15, wherein the planar member has a peripheral edge and further comprising a vertical edge wall that extends upwardly from the peripheral edge, the edge wall including corrugated fiberboard that has been folded upwardly from the planar member.

17. A method of making a product carrier, comprising the actions of:
a. cutting a planar piece of fiberboard to a predetermined dimension to form a rectangular planar member having a bottom side;
b. cutting a cylindrical core lengthwise so as to form two semi-cylindrical core members, each core member including two parallel top edges and a rounded bottom;
c. applying a glue to the top edges of the core members;
d. holding, until the glue sets, the top edges of the core members against the bottom side of the planar member so that the core members are spaced apart and are parallel to each other.

18. The method of claim 17, further comprising the actions of:
a. scoring a lip along each edge of the planar member;
b. cutting slots in selected portions of the lip, thereby creating a plurality of tabs;
c. folding each lip upwardly so as to form an edge wall along a periphery of the planar member; and
d. gluing the plurality of tabs to selected portions of the lip so as to secure the edge wall.

19. The method of claim 17, further comprising the actions of cutting gaps in the core members, the gaps each having a dimension that allows forks of a forklift to fit into the gaps and to engage the product carrier, thereby allowing the forks to engage the product carrier from two transverse directions.

20. The method of claim 17, further comprising the actions of:
a. cutting at least one elongated fiberboard buildup member; and
b. gluing the at least one buildup member to the bottom side of the planar member so that the buildup member is disposed adjacent to one of the parallel edges of at least one elongated core member so as to provide lateral support to at least one of the elongated core members.

21. The method of claim 17, wherein the glue comprising the actions of:
a. applying a foam layer to the rounded bottom of each core member after the gluing action;
b. applying a predetermined force to the foam layer for a predetermined amount of time so as to allow the glue to set; and
c. removing the foam layer from the core member.

22. The method of claim 17, further comprising the actions of:
a. cutting a least one flap into the planar member so that the flap has a shape that is complimentary in shape to an inner surface of the interior portion at least one of the core members;
b. folding the flap downwardly into the open interior portion of at least one of the core members; and
c. gluing the flap to the inner surface so as to provide support to the core member.
